(19) United States
(12) Patent Application Publication
(10) Pub. No.: US 2022/0048542 A1
(43) Pub. Date: Feb. 17, 2022

(54) STORAGE AND TRANSPORT SYSTEM AND METHOD FOR SOLID SODIUM HYPOCHLORITE PENTAHYDRATE

(71) Applicant: Olin Corporation, Clayton, MO (US)

(72) Inventors: William K. White, Clayton, MO (US); Mary Beth Hill, Clayon, MO (US); David W. Cawlfield, Clayton, MO (US); Joseph R. Mock, Clayton, MO (US)

(21) Appl. No.: 17/413,767

(22) PCT Filed: Dec. 17, 2019
(86) PCT No.: PCT/US2019/066840

§ 371 Date: Jun. 14, 2021

Related U.S. Application Data
(60) Provisional application No. 62/780,647, filed on Dec. 17, 2018.

(51) Int. Cl. B61D 5/00; C01B 11/06; B65D 88/74; B61D 17/18; B61D 27/00; B65G 69/04; B65G 69/20; B65G 69/10; B01F 1/00

(52) U.S. Cl. CPC B61D 5/004; C01B 11/062; B61D 5/04; B61D 17/18; B65G 2814/0347; B65G 69/0466; B65G 69/20; B65G 69/10; B01F 1/0022; B61D 27/0081

(57) ABSTRACT

A storage and transport system for sodium hypochlorite pentahydrate (solid bleach) is provided. The system includes a container configured to receive and store crystalline solid bleach that includes of at least forty percent sodium hypochlorite, and to retain decomposition components from crystalline solid bleach stored in the container. The container includes a containment wall at least partially surrounding an interior containment space configured to receive solid bleach therein. A passage extends from exterior the container to the interior containment space. The passage is configured for solid bleach to pass therethrough. A liner is located at an interior surface of the containment wall. The liner is substantially non-reactive with solid bleach and, without leakage, capable of retaining within the containment space: (a) solid bleach, (b) decomposition components of solid bleach and (c) liquid bleach formed when dissolving water is added to solid bleach within the containment space.

### FIELD

The present disclosure relates generally to solid sodium hypochlorite pentahydrate. In particular, the present disclosure relates to methods and systems to store, transport, and unload solid sodium hypochlorite pentahydrate.

### BACKGROUND

There are many uses for sodium hypochlorite (NaOCl), commonly known as bleach in industrial, utility, and residential applications. In many large-scale applications, sodium hypochlorite has traditionally been produced on-site by combining chlorine, alkali, and water. Chlorine is conventionally provided as liquefied chlorine gas in portable cylinders or in rail cars. However there are certain risks and costs associated with the handling, shipping, and storage of liquefied chlorine.

Transportation of bleach solutions is limited by the solubility of sodium hypochlorite in water and by the limited stability of these solutions. Transportation cost of bleach solutions of 15-25% concentrations is higher than the cost of transporting the reactants (50% caustic soda and liquefied chlorine gas) used to produce bleach conventionally, because more mass and volume must be transported per unit of sodium hypochlorite delivered.

### BRIEF DESCRIPTION OF THE DRAWINGS

Implementations of the present technology will now be described, by way of example only, with reference to the attached figures, wherein:

FIG. 1 is a diagrammatic view of an exemplary container;

FIG. 2A is a diagrammatic view of another example of a container;

FIG. 2B is a top perspective view of the container of FIG. 2A;

FIG. 3 is a diagrammatic view of another example of a container;

FIGS. 4A-4D are diagrammatic views of examples of a container;

FIG. 5A is a diagrammatic view of an exemplary filler system;

FIG. 5B is a diagrammatic view of an exemplary spreader which can be used in the filler system of FIG. 5A;

FIG. 6 is a diagrammatic view of another example of a filler system;

FIG. 7 is a diagrammatic view of another example of a filler system;

FIGS. 8A and 8B are diagrammatic views of exemplary extraction systems; and

FIG. 9A, 9B, and 9C are diagrammatic views of exemplary extraction systems.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout the above disclosure will now be presented. The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, “substantially cylindrical” means that the object resembles a cylinder, but can have one or more deviations from a true cylinder. The terms “comprising,” “including” and “having” are used interchangeably in this disclosure. The terms “comprising,” “including” and “having” mean to include, but not necessarily be limited to the things so described. The term “real-time” or “real time” means substantially instantaneously. The term “consist” means containing the so specified element substantially to the exclusion of any other elements.

When storing and transporting crystalline solid sodium hypochlorite pentahydrate (NaOCl.5H₂O) (also referred to herein as “solid bleach”), the containers must include a number of features to maintain the stability of solid bleach, as solid bleach can easily degrade and/or decompose. While the disclosure discusses solid bleach as crystalline solid bleach, in at least one example, a bleach slurry can be used, for example as discussed in U.S. Pat. No. 9,434,616 which is expressly incorporated herein by reference in its entirety. Storage and transportation of liquid bleach solutions is limited by the solubility of sodium hypochlorite in water and by the limited stability of these solutions. As solid bleach is not diluted by water, solid bleach can be more efficiently and economically transported than liquid bleach solutions. For example, a railcar can transport the equivalent of about 60,000 gallons of 12.5 wt % of NaOCl if transporting solid bleach. On the other hand, a railcar can transport only about 20,000 gallons of 12.5 wt % of NaOCl if transporting as a liquid bleach solution. Examples of containers to store and/or transport solid bleach are (1) flexible intermediate bulk containers (IBCs) which can be shipped in a semi-trailer, boxcar, or intermodal dry-freight containers, (2) rigid IBC totes which can be shipped in a semi-trailer, boxcar, or intermodal dry-freight containers, (3) drums which can be shipped in a semi-trailer, boxcar, or intermodal dry-freight containers, (4) intermodal tank pressure vessels, (5) lined intermodal dry-freight containers, and/or (6) dry-freight tank cars.

However, solid bleach can be unstable if not stored in the correct environment. Solid bleach can begin to melt between about 20 degrees Celsius and 29 degrees Celsius, and alternately between about 25 degrees Celsius and 29 degrees Celsius. The liquid formed when solid bleach melts is an unstable solution composed of between about 36 wt % and 45 wt % NaOCl. In at least one example, the liquid formed when solid bleach melts can be an unstable solution composed of up to about 44 wt % NaOCl. When melting, the decomposition reaction of solid bleach is accelerated resulting in the conversion of active ingredient (NaOCl) into contaminants or byproducts such as chlorate, salt, and oxygen gas. As such, solid bleach should be maintained at temperatures below 15 degrees Celsius, and optimally below 5 degrees Celsius. When maintained at a temperature below 5 degrees Celsius, solid bleach is substantially stable and does not decompose.

Additionally, oxygen is an oxidizing gas that must be kept away from reducing agents, combustible materials, and open flames. Exceeding the normal 21% O₂ in air changes ignition and burning characteristics of combustible materials. Accumulation of oxygen within the shipping container is possible, especially upon melting and decomposition of contained solid bleach. As such, a vent may be needed to vent any produced gas, optionally to the atmosphere, and thereby protect the structure of the container from excessive pressure buildup, which could lead to rupturing of the container, and possibly ignition and fire. In the example of non-pressure rated containers, a vent may continuously expel gas outside the container. In other examples, for example with pressure-rated containers, the vent may include a pressure activated relief device to protect against damaging pressure buildup within the container.

Another challenge associated with handling solid bleach is that chlorine gas is generated when the product comes in contact with acidic species. For example, solid bleach can be exposed to CO₂ by contact with ambient air. Pentahydrate crystals formed by cooling crystallization of hypochlorite-containing solutions normally contain only traces of salt or alkali, even when formed from solutions containing excess alkali and salt. The absence of alkali in the crystals themselves creates a sensitivity to contact with carbon dioxide in ambient air. Some solid or liquid alkali such as sodium hydroxide, sodium carbonate, sodium silicate can be added to the solid bleach to increase its ability to absorb carbon dioxide without releasing chlorine. However, in the presence of these alkaline additives, packaging containers must also be able to resist attack by alkalis. Polyesters and polyamides are examples of polymer packaging materials that can be incompatible with alkalis.

Chlorine can begin to form when CO₂ has reacted with all excess alkali (e.g. NaOH) within/on the solid bleach. The leftover CO₂ then begins to react with the sodium hypochlorite, resulting in the formation of chlorine gas. Reactivity and decomposition of solid bleach when contacted with CO₂ creates a challenge for other packaging containers when considering the need to vent excess oxygen formed during rapid decomposition/melting. As such, a one-way vent can be included in the container that allows oxygen to vent from the container without allowing atmospheric air into the container. Additionally, in at least one example, when the stabilizing alkali is an aqueous solution, this solution becomes saturated in hypochlorite by contact with the solid bleach. Accordingly, materials in contact with solid bleach must be compatible with bleach-containing solutions as well.

Solid bleach has the same chemical reactivity as standard sodium hypochlorite solutions and therefore contact with cellulose, organics, and most metals (such as aluminum, carbon steel, zinc or galvanized steel, copper, and brass but excluding tantalum and titanium) must be avoided at all stages of shipping and handling. Additionally, solid bleach reacts slowly with some thermoplastic materials such as polyesters and melamine-formaldehyde. Solid bleach reacts spontaneously with cellulose, increasing the temperature rapidly and emitting steam. Exposure to materials containing nickel can catalyze decomposition of bleach. As such, solid bleach must be stored and transported in a container where the solid bleach is only in contact with compatible metals or plastics, for example polyethylene, polypropylene, polytetrafluouroethylene (PTFE), polyvinyl chloride, and titanium.

It is desirable to maintain bleach in storage in a compact and stable form for as long as possible, as the diluted bleach decomposes more rapidly than the solid phase of bleach. An exemplary solution for shipping solid bleach in a bulk container is to add water to the container in controlled amounts, allowing the solid bleach to dissolve, and then be removed from the container as needed without emptying the entire container at once. Also, it may be desirable to remove liquid without entrained solids, for example, by employing a liquids' outlet behind a screen fine enough to prevent solid bleach crystals from passing therethrough.

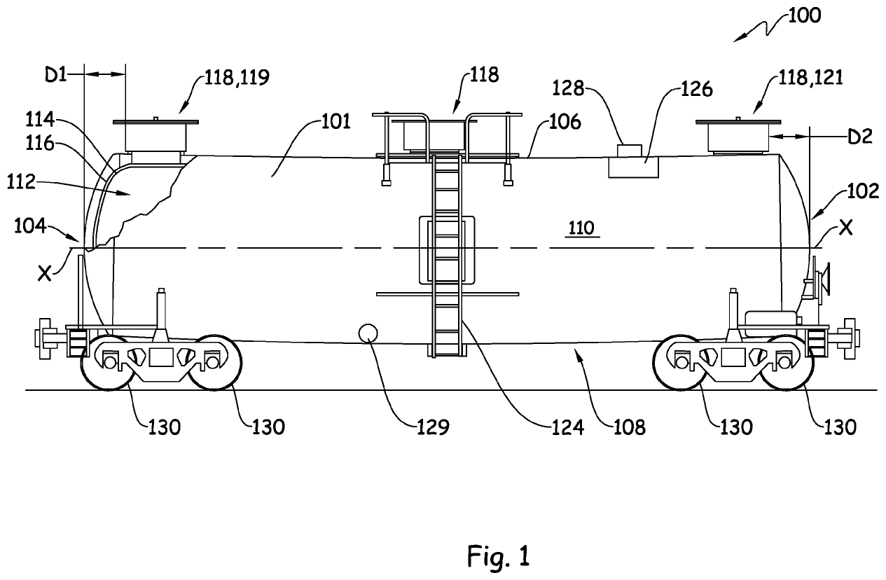

FIGS. 1-4D illustrate exemplary containers 100, 200, 300, 400 for storing and transporting solid sodium hypochlorite pentahydrate (solid bleach). Again, while the disclosure discusses solid bleach as crystalline solid bleach, in at least one example, a bleach slurry can be used as described in U.S. Pat. No. 9,434,616.

An advantage of sodium hypochlorite in a slurry form entrained with crystalline solid bleach is the ability to use existing bleach containers, particularly railcars, for shipping the product. Filling containers with such a slurry allows the use of existing loading openings in the container and the slurry can be formulated so that it has a low angle of repose for more complete filling of, in particular, large containers such as those that are railcar based. A primary reason that the slurry is better is its higher density compared to dry solid bleach and can better weight large containers designed for liquid bleach. At low temperatures, slurries remain pumpable for at least several hours. When a slurry is prepared from stored solid bleach by adding water just before loading, it can be pumped into a railcar or other container. During transportation, slurries can thicken and crystals regrow, but all that is required is adding water or dilute bleach to reestablish the slurry or a liquid solution. When reconstituting with liquid bleach, a flow of bleach solution at 25% weight bleach or less can be pumped into the railcar to dissolve crystals and form a solution that can be pumped, expressed or otherwise removed from the container. If removed through an outlet line, water can be added to the line utilizing density control technology to return the bleach to a desired concentration, ready for storage in an on-site liquid bleach storage tank.

FIG. 1 illustrates an exemplary container 100 which can be a railcar. As illustrated in FIG. 1, the container 100 is a pressurized rail tank car or a tanker, but it should be appreciated that features between the containers 100, 200, 300, 400 described herein can be interchanged as desired. In the instance of FIG. 1, container 100 includes wheels 130 which are compatible with railways. In other examples, the container 100 can be configured to travel on other transportation systems, such as magnetic transportation systems.

The container 100 is configured to receive and store crystalline solid bleach that in dependence upon the methods of manufacture and the product specifications of the particular bleach to be stored or transported in the container 100, can have a sodium hypochlorite content of anywhere from 20-50%, with particularly advantageous compositions containing about 25%, 28% and 40% sodium hypochlorite. The container 100 can also retain decomposition components from the solid bleach stored in the container 100. Additionally, the container 100 can retain diluted liquid bleach solution and/or melted solid bleach.

The container 100 includes a containment wall 116 which at least partially surrounds an interior containment space 112. The containment wall 116 can be made from suitable materials which are compatible with solid bleach. For example, the containment wall 116 can be made from at least one of the following: fiberglass optionally reinforced with plastic, polyethylene, polypropylene, polyvinyl chloride, titanium, stainless steel, and carbon steel. The materials of the containment wall 116 are chosen to withstand pressures and internal and external forces enacted thereon. Additionally, the containment wall 116 is sealed such that fluids such as gases substantially cannot pass through the containment wall 116 between external the container 100 and the interior containment space 112. The interior containment space 112 is configured to receive solid bleach therein.

The container 100 includes a first end 102, a second end 104 opposite the first end 102, an upper surface 106, a lower surface 108 opposite the upper surface 106, and side surfaces 110 which span between the first and second ends 102, 104. The interior containment space 112 is elongate and extends along a longitudinal axis X-X. In at least one example, cross-sections can be taken perpendicular to the longitudinal axis X-X of the interior containment space 112 can be substantially uniform. For example, as illustrated in FIG. 1, the container 100 and the containment space 112 is substantially cylindrical, spanning along the longitudinal axis X-X between the first end 102 and the second end 104.

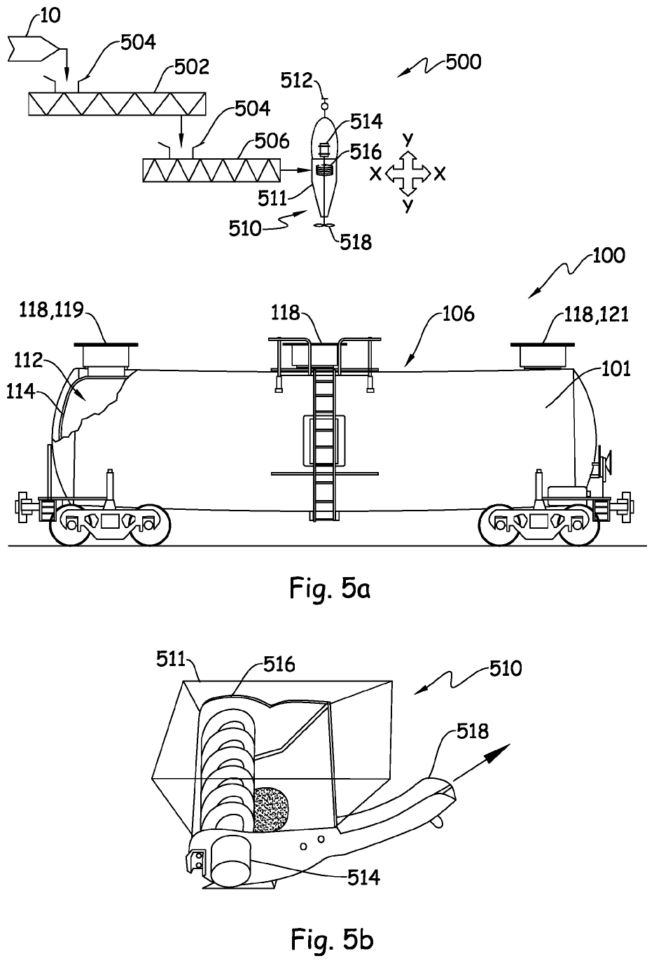

The container 100 also includes at least one passage 118 extending from the exterior of container 100 to the interior containment space 112. The passages 118 are configured for solid bleach to pass therethrough such that the solid bleach can be received within the interior containment space 112. As illustrated in FIG. 1, the container 100 includes three passages 118 disposed along the upper surface 106 of the container 100. In other examples, two, four, or more passages 118 may be included. A pair of passages 119, 121 each is positioned proximate to the two ends 102, 104 of the container 100. Each of the pair of passages 119, 121 are located a predetermined distance D1, D2 from a respective end 104, 102 of the container 100 proximate the passage 119, 121. In at least one example, the predetermined distances D1, D2 that each of the pair of passages 119, 121 is located from the respective end 104, 102 of the container 100 proximate the passage 119, 121 can be substantially equal. In at least one example, the predetermined distances D1, D2 that each of the pair of passages 119, 121 is located from the respective end 104, 102 of the container 100 proximate the passage 119, 121 can be determined in dependence upon spreading characteristics of an associated solid bleach filler system (see for example FIGS. 5A-7). In at least one example, the predetermined distances D1, D2 that each of the pair of passages 119, 121 is located from the respective end 104, 102 of the container 100 proximate the passage 119, 121 can be determined in dependence upon in-container spreading characteristics of an associated solid bleach filler system (see for example FIGS. 5A-7).

In storing and transporting solid bleach, having multiple passages 118 such as the pair of passages 119, 121 proximate to the ends 104, 102 of the container 100 are necessary for loading solid bleach as compared to loading liquid bleach solutions. Additionally, the diameter of the passages 118 may be larger than passages in containers used for liquid bleach solutions, such that the solid bleach can be introduced into the interior containment space 112. In at least one example, the container 100 can include a ladder or elevation assistance device 124 such that a user can traverse the container 100 and gain access to the upper surface 106 and/or the passages 118. Also, the passages 118 are configured to be sealable such that fluids or gases are prevented from passing through the passages 118 when closed.

Additionally, the passages 118 are configured such that dissolving water can be injected therethrough to dissolve the solid bleach to form liquid bleach solution. In at least one example, the passages 118 can be configured such that a solution retrieving device (for example a pump or a dipleg) can be inserted therethrough to access the liquid bleach solution and retrieve the liquid bleach solution out of the interior containment space 112. In at least one example, the solid bleach can be expressed by pressured air and/or liquid.

In some examples, if a dipleg is utilized, the dipleg can be integral and mounted to the container. The dipleg can be supported so that it is not damaged during loading, transport, and/or unloading of the bleach. Additionally, in at least one example, the dipleg can be constructed from a rigid, structurally sound material such as steel which includes a lining compatible with bleach (or other forms or byproducts thereof), such as being encapsulated in polytetrafluoroethylene and/or other fluoropolymers.

In some examples, as illustrated in FIG. 1, the container 100 can include an outlet 129 through which liquid bleach solution can pass such that the liquid bleach solution can be retrieved. In at least one example, the outlet 129 can be positioned proximate to a lower surface or portion 108 of the container 100. In other examples, including a dipleg, the outlet 129 can be positioned proximate to the upper surface 106 of the container 100. When the outlet 129 is proximate to the upper surface or portion 106, the solid bleach (or other forms or byproducts thereof) can be expressed from the container 100 using air pressure and/or water pressure/pumping. The outlet 129 can be, for example, a valve or a spigot. In at least one example, the interior containment space 112 can be configured such that fluids accumulate at a collection point at the outlet 129 such that the fluids can be retrieved by gravity flow. In at least one example, the outlet 129 can include a screen which is fine enough to prevent solid bleach crystals from passing therethrough.

To prevent the solid bleach from contacting the containment wall 116, the container 100 additionally includes a liner 114 located at an interior surface of the containment wall 116. In at least one example, the liner 114 can be adhered to and/or formed on the containment wall 116. In other examples, the liner 114 can be independent from the containment wall 116. The liner 114 is substantially non-reactive with bleach, and particularly solid bleach and, without leakage, is capable of retaining within the interior containment space 112: (a) the solid bleach, (b) decomposition components of solid bleach, and (c) liquid bleach formed when dissolving water is added to the solid bleach. The liquid bleach can be produced when the solid bleach melts. The liner 114 can include or be made entirely of glass. The liner 114 can also include or be made entirely of chlorobutyl rubber, polyethylene and/or polypropylene. In one embodiment, polyethylene is preferred. In at least one example, the liner 114 can include at least one fluoropolymer, such as polytetrafluoroethylene, or other suitable materials such as polymers and epoxies. In all cases, the liner is made of a material or mixture of materials that is substantially non-reactive with solid bleach and any components contained in or derived from solid bleach, where components derived from solid bleach include decomposition products.

Additionally, to maintain the stability of the solid bleach, the container 100 includes refrigeration 126. The refrigeration (source) 126 is capable of maintaining solid bleach in the interior containment space 112 at a temperature below a stabilizing prescribed temperature, for example approximately fifteen degrees Celsius. In at least one example, the refrigeration 126 is capable of maintaining solid bleach in the interior containment space 112 at a temperature below approximately five degrees Celsius. Any suitable components can be utilized in the refrigeration 126 to maintain the temperature of the container, for example a compressor, a refrigerant, a heat sink, a fan, or a gas.

While the refrigeration 126 may maintain the temperature within the interior containment space 112 below a desired temperature, the containment wall 116 may be a warmer temperature and may affect the stability of the solid bleach that comes in contact with the containment wall 116. Solid bleach should be prevented from contact with surfaces warmer than 25 degrees Celsius. To assist in maintaining the temperature within the interior containment space 112, the container 100 can include a refrigeration jacket 101 at least partially surrounding the containment wall 116 with a gap space therebetween. The gap space is configured to receive refrigerated fluid therein and maintain solid bleach contained within the container 100 at a temperature below approximately fifteen degrees Celsius, alternately below approximately five degrees Celsius. In some examples, the refrigerated fluid can be utilized to cool the container 100 through coils laid along the outside of the containment wall 116. In other examples, the coils can be laid along the inside of the containment wall. Additionally, in at least one example, to prevent the solid bleach from melting when received in the interior containment space 112, the refrigeration 126 can be activated prior to filling the container 100 with solid bleach.

In at least one example, the container 100 can include insulation to assist in maintaining the temperature of the container 100 within the interior containment space 112 below the desired temperature. The insulation may be positioned around the interior containment space 112, for example between the containment wall 116 and the interior containment space 112. Typically, the source of refrigeration 126 to the interior containment space 112 will be interior of the insulation. In at least one example, the insulation can include one or more layers of insulation which can include one or more of fiberglass, mineral wool, cellulose, polyurethane, phenolic foam, asbestos or polystyrene. The insulation can be, for example, at least 1.5 inches or 2 inches or 3 inches or 4 inches or 5 inches or 6 inches or more in thickness. The thickness of the insulation will depend, at least in part, on the temperature to be maintained and the insulating material used. The insulation at least partially encapsulates the container 100. In at least one example, the insulation can be surrounded by a jacket, for example a steel jacket. Other configurations or positions of insulation may be utilized as desired so long as the insulation resists the transfer of heat from external the container 100 to within the interior containment space 112. Advantageously, the insulation layer also encompasses the refrigeration source 126.

In at least one example, as illustrated in FIG. 1, the container 100 can include a vent 128. The vent 128 can be configured to vent gas(es), for example oxygen to exterior the container 100 in a controlled manner as oxygen can build up within the interior containment space 112, causing a build-up of pressure and enhancing the possibility of ignition and fire. The vent 128 can be, for example a vent valve which allows the passage of oxygen from the internal containment space 112 to exterior the container 100. In at least one example, the vent 128 can include a pressure relief device that vents gas when the pressure within the container 100 exceeds a predetermined pressure in order to protect the structural integrity of the container 100. In at least one example, the vent 128 can include a micro-porous hydrophobic material that permits the passage of gas, but contains liquids and solids. For example, a micro-porous hydrophobic material can be used that includes polytetrafluoroethylene. The gas-porous material can be incorporated into the construction of the container 100 as a mesh or fabric that serves as part of the wall 116 containing the stored solid and/or liquid bleach, or the polytetrafluoroethylene or equivalent material can be included as a “plug” into the containment wall 116, predominantly serving simply as a vent. When constituting part of the containment wall 116 as a mesh or fabric, the container 100 is typically one of the smaller types, such as drums, rigid totes and flexible bags and sacks.

Also, as solid bleach generates chlorine gas when in contact with acidic species such as CO₂, the container 100 is configured to prevent CO₂ laden ambient air from entering the interior containment space 112. For example, the vent 128 may vent oxygen and other gases from the interior containment space 112, while simultaneously preventing atmospheric air from back-flowing into the space 112. As such, the vent 128 may be a one-way valve configured to release pressure above a predetermined limit.

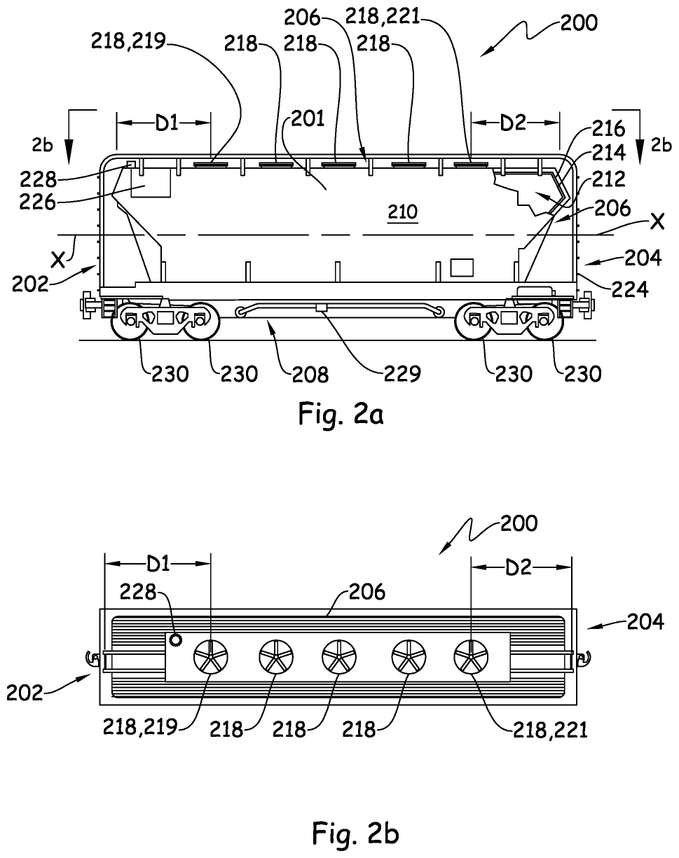

FIGS. 2A and 2B illustrate an exemplary container 200 which can be a railcar. As illustrated in FIGS. 2A and 2B, the container 200 is a non-pressurized rail hopper car. The container 200 includes wheels 230 which are compatible with railways. In other examples, the container 200 can be configured to travel on other transportation systems, such as magnetic transportation systems.

In dependence upon the methods of manufacture and the product specifications of the particular bleach to be stored or transported in a container, according to the present disclosure, exemplary crystalline solid bleach can have a sodium hypochlorite content of anywhere from 20-50%, with particularly advantageous compositions containing about 25%, 28% and 40% sodium hypochlorite. The container 200 can also retain decomposition components from solid bleach stored in the container 200 and/or the products of melted solid bleach.

The container 200 includes a containment wall 216 which at least partially surrounds an interior containment space 212. The containment wall 216 can be made from suitable materials which are compatible with solid bleach. For example, the containment wall 216 can be constructed to include at least one of the following materials: fiberglass optionally reinforced with plastic, polyethylene, polypropylene, polyvinyl chloride, titanium, stainless steel, and/or carbon steel. The materials of the containment wall 216 are chosen to withstand pressures and resist internal and external forces acting thereon. In the configuration of the container 200, the containment wall 216 substantially seals in fluids and gases which are resisted from passing therethrough between external the container 200 and the interior containment space 212. The interior containment space 212 is configured to receive solid bleach therein.

The container 200 includes a first end 202, a second end 204 opposite the first end 202, an upper surface 206 (forming part of an upper portion of the container), a lower surface 208 (forming part of a lower portion of the container) opposite the upper surface 206, and side surfaces 210 which span between the first and second ends 202, 204. The hopper car container 200 is a covered hopper car, such that the interior containment space 212 can be isolated from the external environmental to maintain the stability of the solid bleach. The interior containment space 212 is elongate and extends along a longitudinal axis X-X. In at least one example, cross-sections of at least a portion of the interior containment space 212 taken substantially perpendicular to the longitudinal axis X-X of the interior containment space 212 can be substantially uniform.

The container 200 also includes at least one passage 218 extending from the exterior of container 200 to the interior containment space 212. The passages 218 are configured to permit the passage of solid bleach therethrough such that the solid bleach is received within the interior containment space 212. As illustrated in FIGS. 2A and 2B, the container 200 includes five passages 218 disposed along the upper surface 206 of the container 200. In other examples, two, three, four, or more passages 218 may be included. Each of a pair of passages 219, 221 is positioned proximate to the two ends 202, 204 of the container 200. Each of the pair of passages 219, 221 are located a predetermined distance D1, D2 from a respective end 204, 202 of the container 200. In at least one example, the predetermined distances D1, D2 that each of the pair of passages 219, 221 is located from its respective end 204, 202 of the container 200 is substantially equal. In at least one example, the predetermined distances D1, D2 are determined in dependence upon spreading characteristics of an associated solid bleach filler system (see for example, FIGS. 5A-7). In at least one example, the predetermined distances D1, D2 are determined in dependence upon in-container spreading characteristics of an associated solid bleach filler system (see for example FIGS. 5A-7).

In storing and transporting solid bleach, having multiple passages 218 such as the pair of passages 219, 221 proximate to the ends 204, 202 of the container 200 are necessary for loading solid bleach as compared to loading liquid bleach solutions. Additionally, the diameter of the passages 218 will be larger than passages in containers used for liquid bleach solutions, such that the solid bleach can be introduced into the interior containment space 212. In at least one example, the container 200 can include a ladder or elevation assistance device 224 such that a user can traverse the container 200 and gain access to the upper surface 206 and/or the passages 218. Also, the passages 218 are configured to be sealable such that fluids and/or gases are prevented from passing through the passages 218 when closed.

Additionally, the passages 218 are configured such that dissolving water can be injected therethrough to dissolve the solid bleach to form liquid bleach solution. In at least one example, the passages 218 can be configured such that a solution retrieving device (for example a pump or a dipleg) can be inserted therethrough to access the liquid bleach solution and retrieve the liquid bleach solution out of the interior containment space 212. In at least one example, the solid bleach can be retrieved by pressured air and/or liquid.

In some examples, if a dipleg is utilized, the dipleg can be integral and mounted to the container. In such a configuration, the dipleg will be supported such that it is not damaged during loading, transport, and/or unloading of the solid bleach. Additionally, in at least one example, the dipleg can be constructed from a rigid, structurally sound material such as steel which includes a lining compatible with the solid bleach (or other forms or byproducts thereof), and the dipleg can be encapsulated in polytetrafluoroethylene and/or other fluoropolymers.

In some examples, as illustrated in FIG. 2A, the container 200 can include an outlet 229 through which liquid bleach solution can pass such that the liquid bleach solution can be retrieved. In at least one example, the outlet 229 can be positioned proximate to the lower surface 208 of the container 200. In other examples, for example if a dipleg is utilized, the outlet 229 can be positioned proximate to the upper surface 206 of the container 200. When the outlet 229 is proximate to the upper surface 206, the solid bleach (or other forms or byproducts thereof) can be removed from the container 200 using applied air pressure and/or water pressure, or by pumping. The outlet 229 can be, for example, a valve or a spigot. In at least one example, the interior containment space 212 can be configured so that fluids accumulate at a collection point proximate the outlet 229 such that the fluids can be collected under gravity flow. In at least one example, the outlet 229 can include a screen which is fine enough to prevent solid bleach crystals from passing through.

In some examples, the bleach can be unloaded from the container 200 through pneumatic conveying, mechanical conveying, or by dumping directly into a receiver located below the container.

To prevent the solid bleach from contacting the containment wall 216, the container 200 additionally includes a liner 214 located at an interior surface of the containment wall 216. The liner 214 can be utilized as a barrier to prevent corrosion of the containment wall 216 from the solid bleach. In at least one example, the liner 214 can be adhered to and/or formed on the containment wall 216. In other examples, the liner 214 can be independent from the containment wall 216. The liner 214 is substantially non-reactive with solid bleach and resists leakage of liquids and gases. The liner 214 is advantageously capable of retaining within the interior containment space 212: (a) the solid bleach, (b) decomposition components of solid bleach, and (c) liquid bleach formed when dissolving water is added to the solid bleach. Additionally, the liquid bleach can be present when solid bleach melts. The liner 214 can include or be made entirely of glass, thereby facilitating these characteristics of the liner 214. The liner 214 can also include or be made entirely of chlorobutyl rubber, polyethylene and/or polypropylene. In one embodiment, polyethylene is preferred. In at least one example, the liner 214 can include at least one fluoropolymer, such as polytetrafluoroethylene, or other suitable materials such as polymers and epoxies. In all cases, the liner is made of a material or mixture of materials that is substantially non-reactive with solid bleach and any components contained in or derived from solid bleach, where components derived from solid bleach include decomposition products.

Additionally, to maintain the stability of the solid bleach, the container 200 includes a source of refrigeration 226, herein referred to as “refrigeration.” The refrigeration 226 is capable of maintaining solid bleach in the interior containment space 212 at a temperature below a desired temperature, for example approximately fifteen degrees Celsius. In at least one example, the refrigeration 226 is capable of maintaining solid bleach in the interior containment space 212 at a temperature below approximately five degrees Celsius. Any suitable components can be utilized in the refrigeration 226 to maintain the temperature of the container, for example a compressor, a refrigerant, a heat sink, a fan, and or a gas.

While the refrigeration 226 may maintain the temperature within the interior containment space 212 below a desired temperature, the containment wall 216 may be a warmer temperature and may affect the stability of the solid bleach that comes in contact with the containment wall 216. Solid bleach should be prevented from contact with surfaces warmer than 25 degrees Celsius. To assist in maintaining the temperature within the interior containment space 212, the container 200 can include a refrigeration jacket 201 at least partially surrounding the containment wall 216 with a gap space therebetween. The gap space is configured to receive refrigerated fluid therein and maintain solid bleach contained within the container 200 at a temperature below approximately fifteen degrees Celsius, alternately below approximately five degrees Celsius. In some examples, the refrigerated fluid can be utilized to cool the container 200 through coils laid along the outside of the containment wall 216. In other examples, the coils can be laid along the inside of the containment wall. Additionally, in at least one example, to prevent the solid bleach from melting when received in the interior containment space 212, the refrigeration 226 can be activated prior to filling the container 200 with solid bleach.

In at least one example, the container 200 can contain insulation to assist in maintaining the temperature of the container 200 within the interior containment space 212 below the desired temperature. The insulation may be positioned around the interior containment space 212, for example between the containment wall 216 and the interior containment space 212. In at least one example, the insulation can include one or more layers of insulation which can include one or more of fiberglass, mineral wool, cellulose, polyurethane, phenolic foam, asbestos or polystyrene. The insulation can be, for example, at least 1.5 inches or 2 inches or 3 inches or 4 inches or 5 inches or 6 inches or more in thickness. The thickness of the insulation will depend, at least in part, on the temperature to be maintained and the insulating material used. The insulation at least partially encapsulates the container 200. In at least one example, the insulation can be surrounded by a jacket, for example a steel jacket. Other configurations or positions of insulation may be utilized as desired so long as the insulation decreases the transfer of heat from external the container 200 to within the interior containment space 212.

In at least one example, as illustrated in FIG. 2A, the container 200 can include a vent 228. The vent 228 can be configured to vent gas(es), for example oxygen, to exterior the container 200 in a controlled manner as oxygen can build up within the interior containment space 212, building up pressure and the possibility of ignition and fire. The vent 228 can be, for example a vent valve which allows passage of oxygen from the internal containment space 212 to exterior the container 200. In at least one example, the vent 228 can include a pressure relief device which can vent gas(es) only when the pressure within the container 200 exceeds a predetermined pressure to protect the structural integrity of the container 200. In at least one example, the vent 228 can include a micro-porous hydrophobic material. For example, the micro-porous hydrophobic material can include polytetrafluoroethylene.

Also, as solid bleach generates chlorine gas when in contact with acidic species such as CO₂, the container 200 is configured to prevent ambient air or CO₂ from flowing into the interior containment space 212. For example, the vent 228 may vent oxygen and air from the interior containment space 212 while simultaneously preventing atmospheric air from flowing into the interior containment space 212. As such, the vent 228 may be a one-way valve configured to release pressure above a predetermined limit.

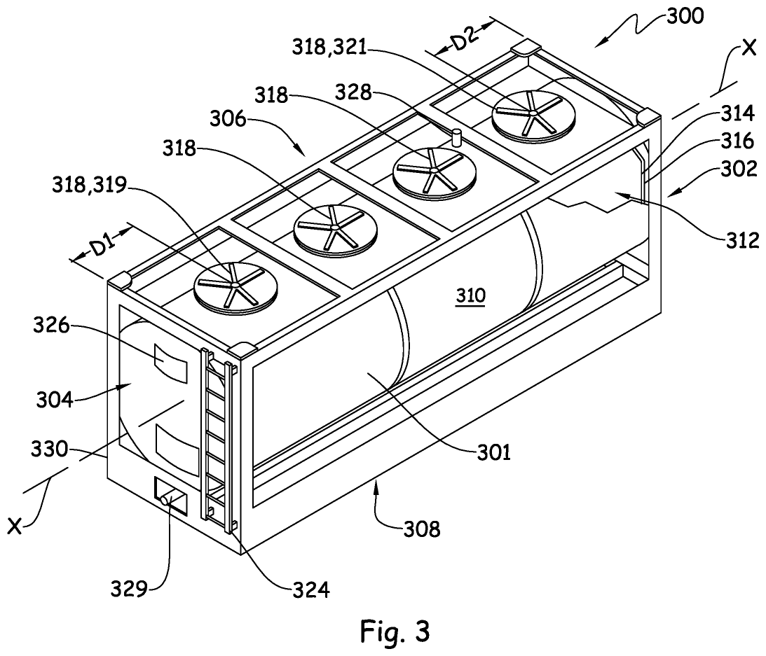

FIG. 3 illustrates an exemplary container 300 which can be an intermodal cargo container box. As illustrated in FIG. 3, the container 300 is an intermodal container configured to be rail transported and the longitudinal axis X-X is substantially horizontally oriented in a transport configuration. The container 300 includes a frame 330 which substantially surrounds the container 300. The frame 330, as illustrated in FIG. 3, forms a substantially rectangular shape. As such, with the frame 330, the containers 300 can be stacked upon one another. In other examples, the frame 330 can be any other suitable shape so long as the top surface and the bottom surface correspond to one another to fit together when stacked. The container 300 can be transported by any suitable method, such as truck, rail or ship.

The container 300 is configured to receive and store crystalline solid bleach as described above. The container 300 can also retain decomposition components from the solid bleach stored in the container 300. The container 300 includes a containment wall 316 which at least partially surrounds an interior containment space 312. The containment wall 316 can be made from suitable materials which are compatible with solid bleach. For example, the containment wall 316 can be made from at least one of the following: fiberglass optionally reinforced with plastic, polyethylene, polypropylene, polyvinyl chloride, titanium, stainless steel, and carbon steel. The materials of the containment wall 316 are chosen to withstand pressures and internal and external forces enacted thereon. Additionally, the containment wall 316 is sealed such that fluids such as gases substantially cannot pass through the containment wall 316 between external the container 300 and the interior containment space 312. The interior containment space 312 is configured to receive solid bleach therein and/or melted solid bleach.

The container 300 includes a first end 302, a second end 304 opposite the first end 302, an upper surface 306, a lower surface 308 opposite the upper surface 306, and side surfaces 310 which span between the first and second ends 302, 304. The interior containment space 312 is elongate and extends along a longitudinal axis X-X. In at least one example, cross-sections can be taken perpendicular to the longitudinal axis X-X of the interior containment space 312 can be substantially uniform. For example, as illustrated in FIG. 3, the container 300 and the containment space 312 is substantially cylindrical, spanning along the longitudinal axis X-X between the first end 302 and the second end 304.

The container 300 also includes at least one passage 318 extending from the exterior of container 300 to the interior containment space 312. The passages 318 are configured for solid bleach to pass therethrough such that the solid bleach can be received within the interior containment space 312. As illustrated in FIG. 3, the container 300 includes four passages 318 disposed along the upper surface 306 of the container 300. In other examples, two, three, or more passages 318 may be included. A pair of passages 319, 321 each is positioned proximate to the two ends 302, 304 of the container 300. Each of the pair of passages 319, 321 are located a predetermined distance D1, D2 from a respective end 304, 302 of the container 300. In at least one example, the predetermined distances D1, D2 that each of the pair of passages 319, 321 is located from the respective end 304, 302 of the container 300 proximate the passage 319, 321 can be substantially equal. In at least one example, the predetermined distances D1, D2 that each of the pair of passages 319, 321 is located from the respective end 304, 302 of the container 300 proximate the passage 319, 321 can be determined in dependence upon spreading characteristics of an associated solid bleach filler system (see for example FIGS. 5A-7). In at least one example, the predetermined distances D1, D2 that each of the pair of passages 319, 321 is located from the respective end 104, 102 of the container 300 proximate the passage 319, 321 can be determined in dependence upon in-container spreading characteristics of an associated solid bleach filler system (see for example FIGS. 5A-7).

In storing and transporting solid bleach, having multiple passages 318 such as the pair of passages 319, 321 proximate to the ends 304, 302 of the container 300 are necessary for loading solid bleach as compared to loading liquid bleach solutions. Additionally, the diameter of the passages 318 may be larger than passages in containers used for liquid bleach solutions, such that the solid bleach can be introduced into the interior containment space 312. In at least one example, the frame 330 can include a ladder or elevation assistance device 324 such that a user can gain access to the upper surface 306 and/or the passages 318. Also, the passages 318 are configured to be sealable such that fluids or gases are prevented from passing through the passages 318 when closed.

Additionally, the passages 318 are configured such that dissolving water can be injected therethrough to dissolve the solid bleach to form liquid bleach solution. In at least one example, the passages 318 can be configured such that a solution retrieving device (for example a pump or a dipleg) can be inserted therethrough to access the liquid bleach solution and retrieve the liquid bleach solution out of the interior containment space 312. In at least one example, the solid bleach can be retrieved by pressured air and/or liquid.

In some examples, if a dipleg is utilized, the dipleg can be integral and mounted to the container. The dipleg can be supported so that the dipleg is not damaged during loading, transport, and/or unloading of the solid bleach. Additionally, in at least one example, the dipleg can be constructed from a rigid, structurally sound material such as steel which includes a lining compatible with the solid bleach (or other forms or byproducts thereof), and the dipleg can be encapsulated in polytetrafluoroethylene and/or other fluoropolymers.

In some examples, as illustrated in FIG. 3, the container 300 can include an outlet 329 through which liquid bleach solution can pass such that the liquid bleach solution can be retrieved. In at least one example, the outlet 329 can be positioned proximate to the lower surface 308 of the container 300. In other examples, for example if a dipleg is utilized, the outlet 329 can be positioned proximate to the upper surface 306 of the container 300. When the outlet 329 is proximate to the upper surface 306, the solid bleach (or other forms or byproducts thereof) can be removed from the container 300 using air pressure and/or water pressure/pumping. The outlet 329 can be, for example, a valve or a spigot. In at least one example, the interior containment space 312 can be configured such that fluids accumulate at a collection point at the outlet 329 such that the fluids can be retrieved by gravity flow. In at least one example, the outlet 329 can include a screen which is fine enough to prevent solid bleach crystals from passing through.

To prevent the solid bleach from contacting the containment wall 316, the container 300 additionally includes a liner 314 located at an interior surface of the containment wall 316. The liner 314 can be utilized as a barrier to prevent corrosion of the containment wall 316 from the solid bleach. In at least one example, the liner 314 can be adhered to and/or formed on the containment wall 316. In other examples, the liner 314 can be independent from the containment wall 316. The liner 314 is substantially non-reactive with solid bleach and, without leakage, is capable of retaining within the interior containment space 312: (a) the solid bleach, (b) decomposition components of solid bleach, (c) and liquid bleach formed when dissolving water is added to the solid bleach. Additionally, the liquid bleach can be present when the solid bleach melts. The liner 314 can include or be made entirely of glass. The liner 314 can also include or be made entirely of chlorobutyl rubber, polyethylene and/or polypropylene. In one embodiment, polyethylene is preferred. In at least one example, the liner 314 can include at least one fluoropolymer, such as polytetrafluoroethylene, or other suitable materials such as polymers and epoxies. In all cases, the liner is made of a material or mixture of materials that is substantially non-reactive with solid bleach and any components contained in or derived from solid bleach, where components derived from solid bleach include decomposition products.

Additionally, to maintain the stability of the solid bleach, the container 300 includes refrigeration 326. The refrigeration 326 is capable of maintaining solid bleach in the interior containment space 312 at a temperature below a desired temperature, for example approximately fifteen degrees Celsius. In at least one example, the refrigeration 326 is capable of maintaining solid bleach in the interior containment space 312 at a temperature below approximately five degrees Celsius. Any suitable components can be utilized in the refrigeration 326 to maintain the temperature of the container, for example a compressor, a refrigerant, a heat sink, a fan, or a gas.

While the refrigeration 326 may maintain the temperature within the interior containment space 312 below a desired temperature, the containment wall 316 may be a warmer temperature and may affect the stability of the solid bleach that comes in contact with the containment wall 316. Solid bleach should be prevented from contact with surfaces warmer than 25 degrees Celsius. To assist in maintaining the temperature within the interior containment space 312, the container 300 can include a refrigeration jacket 301 at least partially surrounding the containment wall 316 with a gap space therebetween. The gap space is configured to receive refrigerated fluid therein and maintain solid bleach contained within the container 300 at a temperature below approximately fifteen degrees Celsius, alternately below approximately five degrees Celsius. In some examples, the refrigerated fluid can be utilized to cool the container 300 through coils laid along the outside of the containment wall 316. In other examples, the coils can be laid along the inside of the containment wall. Additionally, in at least one example, to prevent the solid bleach from melting when received in the interior containment space 312, the refrigeration 326 can be activated prior to filling the container 300 with solid bleach.

In at least one example, the container 300 can contain insulation to assist in maintaining the temperature of the container 300 within the interior containment space 312 below the desired temperature. The insulation may be positioned around the interior containment space 312, for example between the containment wall 316 and the interior containment space 312. In at least one example, the insulation can include one or more layers of insulation which can include one or more of fiberglass, mineral wool, cellulose, polyurethane, phenolic foam, asbestos or polystyrene. The insulation can be, for example, at least 1.5 inches or 2 inches or 3 inches or 4 inches or 5 inches or 6 inches or more in thickness. The thickness of the insulation will depend, at least in part, on the temperature to be maintained and the insulating material used. The insulation at least partially encapsulates the container 300. In at least one example, the insulation can be surrounded by a jacket, for example a steel jacket. Other configurations or positions of insulation may be utilized as desired so long as the insulation decreases the transfer of heat from external the container 300 to within the interior containment space 312.

In at least one example, as illustrated in FIG. 3, the container 300 can include a vent 328. The vent 328 can be configured to vent gas(es), for example oxygen, to exterior the container 300 in a controlled manner as oxygen can build up within the interior containment space 312, building up pressure and the possibility the combustion. The vent 328 can be, for example a vent valve which allows passage of oxygen from the internal containment space 312 to exterior the container 300. In at least one example, the vent 328 can include a pressure relief device which can vent gas(es) only when the pressure within the container 300 exceeds a predetermined pressure to protect the structural integrity of the container 300. In at least one example, the vent 328 can include a micro-porous hydrophobic material. For example, the micro-porous hydrophobic material can include polytetrafluoroethylene.

Also, as solid bleach generates chlorine gas when in contact with acidic species such as CO₂, the container 300 is configured to prevent ambient air or CO₂ from flowing into the interior containment space 312. For example, the vent 328 may vent oxygen and air from the interior containment space 312 while simultaneously preventing atmospheric air from flowing into the interior containment space 312. As such, the vent 328 may be a one-way valve configured to release pressure above a predetermined limit.

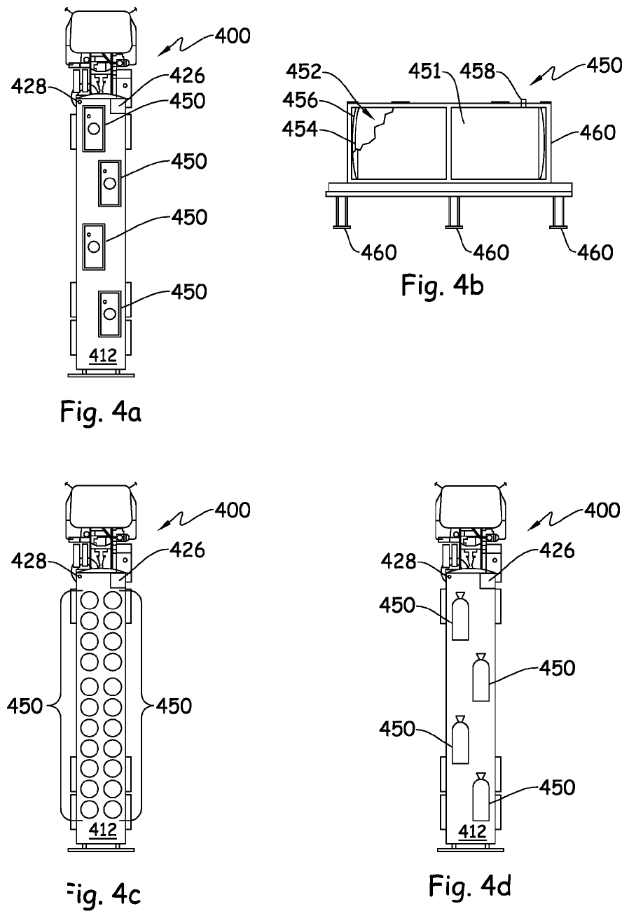

FIGS. 4A-4D illustrate exemplary containers 400 which can be, for example railcars or trucks, or other transportation vehicles that have one or more sub-container spaces 412 to receive and store one or more sub-containers 450.

FIGS. 4A-4D illustrate different examples of sub-containers 450; however the features are similar between each example. For example, FIGS. 4A and 4B illustrate a sub-container 450 with a substantially rectangular shape, such as rigid intermediate bulk containers (IBCs). Solid bleach can be loaded in rigid IBCs through a top port. In at least one example, the rigid IBCs can be constructed from plastic material, for example high density polyethylene, and an outlet valve can be located at a bottom of the rigid IBCs. FIG. 4C illustrates a sub-container 450 with a substantially cylindrical shape, such as an open-top plastic drum and/or a metal drum with a lid. The plastic drum may include a liner, while a metal drum requires the use of a liner. FIG. 4D illustrates a sub-container 450 which is flexible, such as a bag or a flexible IBC.

As detailed in FIG. 4B, each of the sub-containers 450 are configured to receive and store crystalline solid bleach (and/or bleach slurry) as described above. The sub-container 450 can also retain decomposition components from the solid bleach stored in the sub-container 450. The sub-containers 450 include a containment wall 456 which at least partially surrounds an interior containment space 452. The containment wall 456 can be made from suitable materials which are compatible with solid bleach. For example, the containment wall 456 can be made from at least one of the following: fiberglass optionally reinforced with plastic, polyethylene, polypropylene, polyvinyl chloride, titanium, stainless steel, and carbon steel. The materials of the containment wall 456 are chosen to withstand pressures and internal and external forces enacted thereon. Additionally, the containment wall 456 is sealed such that fluids such as gases substantially cannot pass through the containment wall 456 between external the sub-container 450 and the interior containment space 452. The interior containment space 452 is configured to receive solid bleach therein.

In at least one example, as illustrated in FIG. 4B, the sub-container 450 can be reinforced with structural supports 460 which prevent movement of the sub-container 450, even when the contents are melted. For example, if the sub-container 450 is flexible such as in FIG. 4D, when the solid bleach has been dissolved into a liquid bleach solution, the structural integrity is diminished, and the sub-container 450 can roll out of position due to the fluidity of the contents. As such, the structural support 460 maintains the structural integrity and positioning of the sub-container 450 regardless of the state of the sub-container 450. In at least one example, the structural support 460 can include corrugated plastic such as polyethylene or chlorinated polyvinyl chloride (CPVC). In some embodiments, the structural support 460 is used in combination with a sub-container 450 that has structural support, such as one or more baffles and/or ribs, sown onto, woven into or otherwise contained in or on the sub-container 450. In some cases, the structural support 460 is not used, when the sub-container 450 has structural support built into it. When the structural support is built into the sub-container 450, the sub-container 450 is less likely to roll or tip or more preferably, does not roll or tip.

In at least one example, the containment wall 456 may not be compatible with the solid bleach. To prevent the solid bleach contained within the sub-container 450 from contact with the containment wall 456, the sub-container 450 can additionally include a liner 454 located at an interior surface of the containment wall 456. The liner 454 can be utilized as a barrier to prevent corrosion of the containment wall 456 from the solid bleach. In at least one example, the liner 454 can be adhered to and/or formed on the containment wall 456. In other examples, the liner 454 can be independent from the containment wall 456. The liner 454 is substantially non-reactive with solid bleach and, without leakage, is capable of retaining within the interior containment space 452: (a) the solid bleach, (b) decomposition components of solid bleach, (c) and liquid bleach formed when dissolving water is added to the solid bleach. Additionally, the liquid bleach can be present when the solid bleach melts. For example, flexible IBCs may be required to include a liner 454 while drums and rigid IBCs made of compatible plastic may not include a liner 454. The liner 454 can include or be made entirely of glass. The liner 454 can also include or be made entirely of chlorobutyl rubber, polyethylene and/or polypropylene. In one embodiment, polyethylene is preferred. In at least one example, the liner 454 can include at least one fluoropolymer, such as polytetrafluoroethylene, or other suitable materials such as polymers and epoxies. In all cases, the liner is made of a material or mixture of materials that is substantially non-reactive with solid bleach and any components contained in or derived from solid bleach, where components derived from solid bleach include decomposition products.

In at least one example, as illustrated in FIG. 4B, the sub-container 450 can include a vent 458. Oxygen and possibly other gases can build up within the interior containment space 452 of sub-container 450, by for example, the melting and decomposition of the solid bleach. This gas formation increases the pressure inside of sub-container 450, and may lead to an increased risk of rupturing and/or ignition and fire. The vent 458 can be configured to vent the oxygen and/or any other gases to outside of sub-container 450, in a controlled manner. In at least one example, the vent 458 can include a micro-porous hydrophobic material. For example, the micro-porous hydrophobic material can include polytetrafluoroethylene.

In at least one example, the sub-container 450 may be a pressure-rated container. As such, the vent 458 can include a pressure relief device which can vent gas(es) only when the pressure within the sub-container 450 exceeds a predetermined pressure to protect the structural integrity of the sub-container 450.

Also, as solid bleach generates chlorine gas when in contact with acidic species such as CO₂, the sub-container 450 is configured to prevent ambient air or CO₂ from flowing into the interior containment space 452. Gas formation within the sub-container 450 will lead to an increase in pressure, within the sub-container 450, which could lead to rupturing of the sub-container 450. Pressure relief device 458 may prevent over pressurization by venting oxygen and air from the interior containment space 452. Preferably, device 458 simultaneously prevents atmospheric air, which contains CO₂, from flowing into the interior containment space 452. As such, the pressure relief device 458 may be a one-way valve that is configured to release gas, and thereby reduce the pressure within the sub-container 450, once the pressure in the sub-container reaches a predetermined pressure. The predetermined pressure will depend on the type of container being used.

To maintain the stability of the solid bleach, the container 400 includes refrigeration unit 426. To be clear, the refrigeration unit 426 is not part of the container 450. Rather, refrigeration unit 426 is part of the container 400, that is transporting one or more containers 450. In FIGS. 4a, 4c and 4d, container 400 is a truck, such as a semi-trailer. Other containers 400 may be used to transport the one or more containers 450. The refrigeration unit 426 is capable of maintaining solid bleach in the interior containment space 452 of the sub-containers 450 at a temperature below a desired temperature, for example approximately fifteen degrees Celsius. In at least one example, the refrigeration unit 426 is capable of maintaining solid bleach in the interior containment space 452 of the sub-containers 450 at a temperature below approximately five degrees Celsius. Any suitable components can be utilized in the refrigeration unit 426 to maintain the temperature of the container, for example a compressor, a refrigerant, a heat sink, a fan, or a gas. In some examples, the refrigerated fluid can be utilized to cool the container 400 through coils laid along the outside of the containment wall. In other examples, the coils can be laid along the inside of the containment wall. Additionally, in at least one example, to prevent the solid bleach from melting when received in the interior containment space 412, the refrigeration unit 426 can be activated prior to filling the container 400 with solid bleach.

In at least one example, the container 400 can contain insulation to assist in maintaining the temperature of the container 400 within the interior containment space 412 below the desired temperature. The insulation may be positioned around the interior containment space 412, for example between the containment wall and the interior containment space 412. In at least one example, the insulation can include one or more layers of insulation which can include one or more of fiberglass, mineral wool, cellulose, polyurethane, phenolic foam, asbestos or polystyrene. The insulation can be, for example, at least 1.5 inches or 2 inches or 3 inches or 4 inches or 5 inches or 6 inches or more in thickness. The thickness of the insulation will depend, at least in part, on the temperature to be maintained and the insulating material used. The insulation at least partially encapsulates the container 400. In at least one example, the insulation can be surrounded by a jacket, for example a steel jacket. Other configurations or positions of insulation may be utilized as desired so long as the insulation decreases the transfer of heat from external the container 400 to within the interior containment space 412.

In at least one example, to maintain the temperature of the sub-containers 450, the sub-containers 450 can be kept cool through circulation of fluid, such as air, throughout the container 400. The sub-containers 450 can be positioned such that there is a gap between the sub-containers 450 and the walls of the container 400 to promote fluid circulation. For example, the sub-containers 450 may include supports to provide a space between the sub-container 450 and the walls of the container 400. In at least one example, the supports may be built-in to the sub-container 450. In other examples, the sub-containers 450 may be placed on pallets, for example plastic pallets.

In at least one example, the sub-containers 450 can include a refrigeration jacket 451 at least partially surrounding the containment wall 451 with a gap space therebetween. The gap space is configured to receive refrigerated fluid therein and assist in maintain solid bleach contained within the sub-containers 450 at a temperature below approximately fifteen degrees Celsius, alternately below approximately five degrees Celsius. In other examples, the gap space can be a vacuum, providing for insulation. In yet other examples, the gap space can be filled with an insulating material.

In at least one example, as illustrated in FIGS. 4A, 4C, and 4D, the container 400 can also include a vent 428. The vent 428 can be configured to vent oxygen to exterior the container 400 in a controlled manner as oxygen can build up within the sub-container space 412, building up pressure and the possibility of ignition and fire. The vent 428 can be, for example a vent or a vent valve which allows passage of oxygen from the sub-container space 412 to exterior the container 400. In at least one example, the vent 128 can include a pressure relief device which can vent gas(es) only when the pressure within the container 100 exceeds a predetermined pressure to protect the structural integrity of the container 100.

Also, as solid bleach generates chlorine gas when in contact with acidic species such as CO₂, the container 400 can be configured to prevent ambient air or CO₂ from flowing into the sub-container space 412. For example, the vent 428 may vent oxygen and air from the sub-container space 412 while simultaneously preventing atmospheric air from flowing into the sub-container space 412. As such, the vent 428 may be a one-way valve configured to release pressure above a predetermined limit.

FIGS. 5A-7 illustrate exemplary filler systems to fill a container 100, 200, 300 with solid bleach for storage and/or transport. Again, while the disclosure discusses solid bleach as crystalline solid bleach, in at least one example, a bleach slurry can be used as described in U.S. Patent No. 9,434,616. Features between the containers 100, 200, 300, 400 can be interchanged as desired. Any of containers 100, 200, 300 and 450 can be utilized with any of the below exemplary systems. Additionally, any of the features of the filler systems 500, 600, 700 can be utilized in any other filler system 500, 600, 700 as desired.

FIG. 5A illustrates an exemplary filler system 500 to fill a container 100 with a predetermined amount of solid bleach 10. While container 100 is illustrated in FIG. 5, any other suitable containers can be utilized.

The filler system 500 is configured to convey solid bleach 10 from a supply source to and through a passage 118 and into the interior containment space 112. The filler system 500, as illustrated in FIG. 5A, includes a series of conveyance pathways 502, 506. A first conveyance pathway 502 receives the solid bleach 10 from the supply source. As illustrated, the first conveyance pathway 502 includes a funnel 504 to ensure efficient reception of the solid bleach 10. The first conveyance pathway 502 transfers the solid bleach 10 to a second conveyance pathway 506 through a funnel 508. In at least one example, funnels 504, 508 are not utilized. Additionally, in at least one example, the filler system 500 may include one, two, three, or more than three conveyance pathways 502, 506. In at least one example, at least one of the conveyance pathways 502, 506 can include a screw conveyor. In at least one example, the filler system 500 can pneumatically convey the solid bleach 10 along at least a portion of the conveyance pathway 502, 506 between the supply source and the interior containment space 112. For example, the conveyance pathways 502, 506 can be insulated PVC or CPVC pipes. The conveyance pathways 502, 506 can be enclosed from the ambient atmosphere and into which CO₂ scrubbed air is injected. In at least one example, the conveyance pathways 502, 506 can have nitrogen injected therein. Additionally, the conveyance pathways 502, 506 can be maintained at a predetermined temperature such as below approximately fifteen degrees Celsius, alternately approximate five degrees Celsius. In at least one example, the air temperature in the conveyance pathways 502, 506 can be about −18 degrees Celsius, or a suitable temperature such that moisture in the solid bleach 10 freezes. As such, the stability of the solid bleach 10 can be maintained.

The filler system 500 also includes a spreader 510 that in a filling configuration is located proximate to passage 118 and is configured to spread solid bleach 10 within the interior containment space 112 as far as a lengthwise center-point of the interior containment space 112. The spreader 510 can be coupled with and maneuvered, for example, by a hoist 512. For example, the spreader 510 can be moved along the X and/or Y axis. The spreader 510 can be maneuvered to be located proximate any of the passages 118 of the container 100 such that the interior containment space 112 can be substantially evenly filled, or filled as desired, with solid bleach 10.

The spreader 510 can receive the solid bleach 10 from the conveyance pathway 506 in a housing 511. The spreader 510 can include a motor 514 which can translate a distributor 516 disposed within the housing 511. The distributor 516 is configured to distribute, substantially uniformly, solid bleach 10 from below the spreader 510 to at least as far as a width-wise centerline located at the lengthwise center-point of the interior containment space 112. The distributor 516 can be, for example, a screw shape such that the motor 514 can rotate the distributor 516, and the distributor 516 evenly transfers the solid bleach 10 through the housing 511 and distributes the solid bleach 10.

In at least one example, the spreader 510 can also include a rotary head 518 that broadcasts, substantially uniformly, solid bleach 10 from below the spreader 510 to at least as far as a width-wise centerline located at the lengthwise center-point of the interior containment space 112. The rotary head 518 can be coupled with the motor 512. In at least one example, the rotary head 518 can be coupled with the distributor 516 and rotates simultaneously with the distributor 516. In other examples, the rotary head 518 can be coupled with a separate motor to independently rotate the rotary head 518.

FIG. 5B illustrates another example of a spreader 510. Instead of including a rotary head 518 that rotates, the spreader 510 as illustrated in FIG. 5B can eject the solid bleach 10 through the head 518 at a velocity to broadcast the solid bleach 10. The spreader 510 as a unit can be rotated to direct the direction that the spreader 510 broadcasts the solid bleach 10. In other examples, the head 518 can be independently rotated to direct the direction that the spreader 510 broadcasts the solid bleach 10. FIG. 5B uses a screw conveyor to move the solid bleach 10.

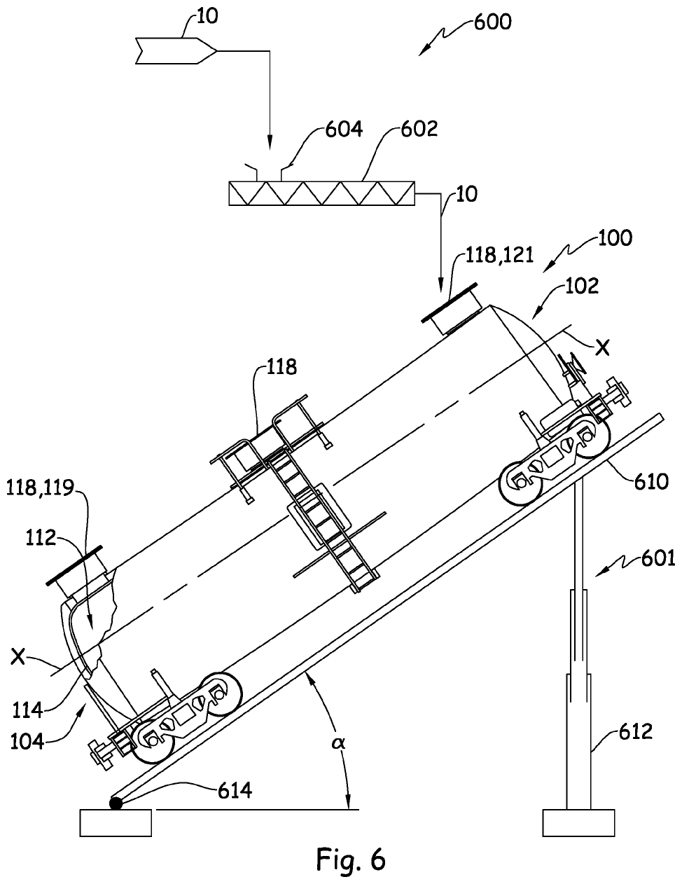

FIG. 6 illustrates an exemplary filler system 600 which utilizes a container tilting system 601 to fill a container 100 with solid bleach 10. While container 100 is illustrated in FIG. 6, any other suitable containers can be utilized. When the container 100 is incorporated into a railcar, the tilting system 601 is for the entire railcar, including the container 100.

The filler system 600 is configured to convey solid bleach 10 from a supply source to and through a passage 118 and into the interior containment space 112. The filler system 600, as illustrated in FIG. 6, includes a conveyance pathway 602. The conveyance pathway 602 receives the solid bleach 10 from the supply source. As illustrated, the conveyance pathway 602 includes a funnel 604 to ensure efficient reception of the solid bleach 10. The conveyance pathway 602 transfers the solid bleach 10 into the container 100. In at least one example, the funnel 604 is not utilized. Additionally, in at least one example, the filler system 600 may include one, two, three, or more than three conveyance pathways 602. In at least one example, the conveyance pathway 602 can include a screw conveyor.

In at least one example, the filler system 600 can pneumatically convey the solid bleach 10 along at least a portion of the conveyance pathway 602 between the supply source and the interior containment space 112. For example, the conveyance pathway 602 can be insulated PVC or CPVC pipes. The conveyance pathway 602 can be enclosed from the ambient atmosphere and into which CO₂ scrubbed air is injected. In at least one example, the conveyance pathway 602 can have nitrogen injected therein. Additionally, the conveyance pathway 602 can be maintained at a predetermined temperature such as below approximately fifteen degrees Celsius, alternately approximate five degrees Celsius. In at least one example, the air temperature in the conveyance pathway 602 can be about −18 degrees Celsius, or a suitable temperature such that moisture in the solid bleach 10 freezes. As such, the stability of the solid bleach 10 can be maintained.

The container tilting system 601 includes a platform 610 upon which the container 100 can be positioned. The container tilting system 601 is capable of lengthwise tilting a container 100 at an angle α to horizontal. The angle of tilt establishes a tilt angle α of a longitudinal axis X-X of the container 100 and the angle of tilt is a complementary angle to the angle of repose of solid bleach 10. The tilt angle α can be between approximately 30 degrees and 80 degrees. In at least one example, the tilt angle α can be between approximately 35 to 75 degrees or approximately 40 degrees and 70 degrees.

The container tilting system 601 tilts the container 100 pivoting the platform 610 about a point 614. The point 614 can be, for example, a hinge or a bearing. One or more pistons 612 coupled with the platform 610 at an end of the platform 610 opposite the point 614. In at least one example, the pistons 612 can be coupled to the bottom of the platform 610. In other examples, the pistons 612 can be coupled to the sides of the platform 610. When the pistons 612 extend, from a retracted configuration to an extended configuration, the pistons 612 raise the platform 610. However, as an end of the platform 610 is stationary at point 614, the platform 610 tilts to the predetermined angle α. In other examples, the platform 610 can be lifted instead of pushed by pistons 612.

While the container 100 is tilted, the filler system 600 can convey the solid bleach 10 into the container 100. In at least one example, the solid bleach 10 can be deposited into the container 100 through the passage 121 which is proximate the end 102 of the container 100 which is tilted up. Additionally, in at least one example, the filler system 600 can include a shaker to shake the container 100 such that the solid bleach 10 compactly fills up the container 100. As such, the solid bleach 10 accumulates at the end 104 of the container 104 which is proximate the point 614 and lower. As such, the filler system 600 efficiently deposits the solid bleach 10 into the container 100 without excessive moving parts.

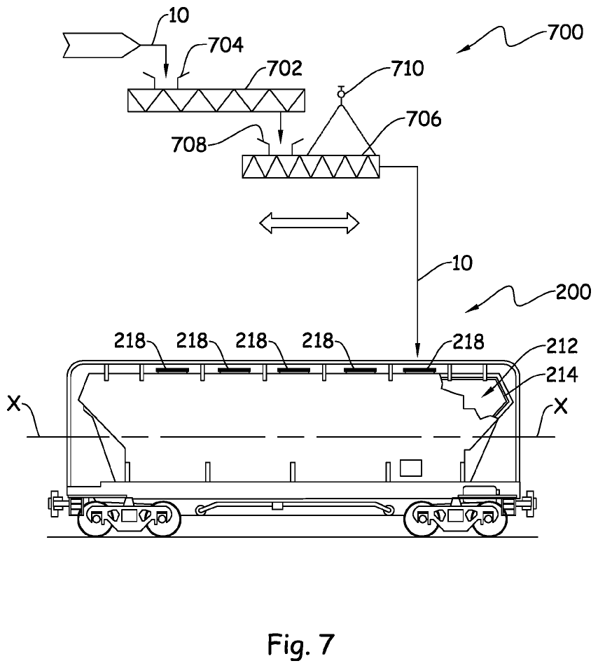

FIG. 7 illustrates an exemplary filler system 700 which to fill a container 200 with a predetermined amount of solid bleach 10. While container 200 is illustrated in FIG. 7, any other suitable containers can be utilized.

The filler system 700 is configured to convey solid bleach 10 from a supply source to and through a passage 218 and into the interior containment space 212. The filler system 700, as illustrated in FIG. 7, includes a series of conveyance pathways 702, 706. A first conveyance pathway 702 receives the solid bleach 10 from the supply source. As illustrated, the first conveyance pathway 702 includes a funnel 704 to ensure efficient reception of the solid bleach 10. The first conveyance pathway 702 transfers the solid bleach 10 to a second conveyance pathway 7506 through a funnel 708. In at least one example, funnels 704, 708 are not utilized. Additionally, in at least one example, the filler system 700 may include one, two, three, or more than three conveyance pathways 702, 706. In at least one example, at least one of the conveyance pathways 702, 706 can include a screw conveyor. In at least one example, the filler system 700 can pneumatically convey the solid bleach 10 along at least a portion of the conveyance pathways 702, 706 between the supply source and the interior containment space 212. For example, the conveyance pathways 702, 706 can be insulated PVC or CPVC pipes. The conveyance pathways 702, 706 can be enclosed from the ambient atmosphere and into which CO₂ scrubbed air is injected. In at least one example, the conveyance pathways 702, 706 can have nitrogen injected therein. Additionally, the conveyance pathways 702, 706 can be maintained at a predetermined temperature such as below approximately fifteen degrees Celsius, alternately approximate five degrees Celsius. In at least one example, the air temperature in the conveyance pathways 702, 706 can be about −18 degrees Celsius, or a suitable temperature such that moisture in the solid bleach 10 freezes. As such, the stability of the solid bleach 10 can be maintained.

As illustrated in FIG. 7, conveyor pathway 706 can be coupled with and maneuvered, for example, by a hoist 710. For example, the conveyor pathway 706 can be moved along the X and/or Y axis. The conveyor pathway 706 can be maneuvered to be located proximate any of the passages 218 of the container 200 such that the interior containment space 212 can be substantially evenly filled, or filled as desired, with solid bleach 10.

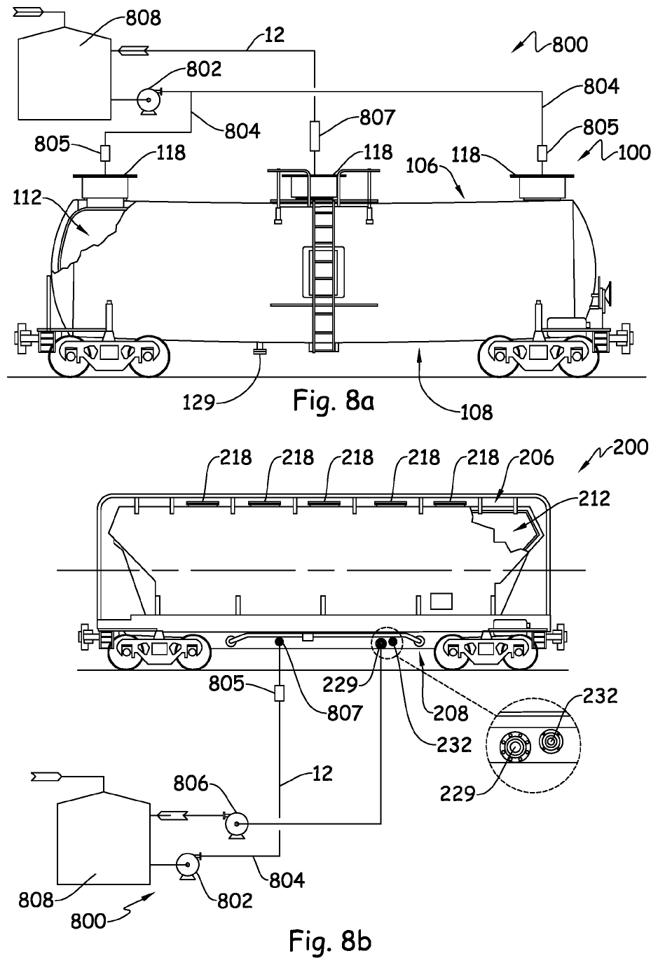

FIGS. 8A and 8B illustrate exemplary extraction systems 800. Any of containers 100, 200, 300 and 450 can be utilized with any of the below exemplary systems.

The extraction system 800 includes a fluid delivery system 802 configured to deliver water 804 into the interior containment space 112 of the container 100. While the disclosure herein discusses water as the fluid delivered by the fluid delivery system 802, in at least one example, the fluid delivery system 802 delivers diluted liquid bleach solution into the interior containment space 112 of the container 100 to dissolve the solid bleach 10. The fluid delivery system 802 can include one or more injectors 805 to deliver water 804 into the interior containment space 112. The fluid delivery system 802 can include pumps to pump the water 804 through the injectors 805. In at least one example, the injectors 805 can be extendable into the interior containment space 112 through the passages 118. The water 804 dissolves a portion of the solid bleach stored within the container 100.

The extraction system 800 can also include an inlet 807 positioned at a collection point for diluted liquid bleach produced by delivered water 804 mixed with stored solid bleach in the interior containment space 112. For example, the inlet 807 can be positioned at the outlet 129, and the collection point for the diluted liquid bleach solution 12 is located at a lower portion of the container 100 proximate the lower surface 108 and into which diluted liquid bleach solution 12 gravity flows. For example, the inlet 807 can be positioned on or near surface 106, to allow fluid communication between the outlet 129 and the inlet 807.

In at least one example, the extraction system 800 includes a fluid extraction device 806 (not shown) which can be extended through the passages 118 into the interior containment space 112 to extract the diluted liquid bleach solution 12 from the container 100. The fluid extraction device 806 can be, for example, a dipleg. In at least one example, the diluted liquid bleach solution 12 can be re-injected to the interior containment space 112 to further mix with the water 850 and, in some examples, additional solid bleach until the concentration of the diluted liquid bleach solution 12 is as desired.

As illustrated in FIG. 8B, the fluid delivery system 802 can be configured to deliver water 804 into the interior containment space 212 of the container 100 through a fluid inlet 232. As illustrated in FIG. 8B, the fluid inlet 232 is positioned proximate the lower surface 208 of the container 200. In other examples, the fluid inlet 232 can be positioned proximate the upper surface 206 of the container 200. The fluid inlet 232 provides for fluid communication from exterior the container 200 to inside the interior containment space 212. However, when in a closed configuration, the fluid inlet 232 is sealed such that fluids cannot pass through. Additionally, a plurality of fluid inlets 232 can be positioned about the container 200 such that the water 804 can be injected throughout the interior containment space 212 to sufficiently and efficiently dissolve the solid bleach. The injectors 805 can be positioned against the fluid inlets 232 such that water can be injected through the injectors 805 through the fluid inlets 232 into the interior containment space 212. The fluid delivery system 802 can include pumps to pump the water 804 through the injectors 805.

As illustrated in FIG. 8B, the outlet 229 is positioned proximate the lower surface 208 of the container 200. The outlet 229 can be in fluid communication with the interior containment space 212, for example proximate the collection point such that the diluted liquid bleach solution 12 can gravity flow to and through the outlet 229 when the outlet is in an open configuration. When the outlet 229 is in a closed configuration, the outlet 229 is sealed such that fluid cannot pass through the outlet 229. The inlet 807 can be positioned at the outlet 229, and the collection point for the diluted liquid bleach solution 12 is located at a lower portion of the container 200 proximate the lower surface 208 and into which diluted liquid bleach solution 12 gravity flows. For example, the inlet 807 can be positioned against the outlet 229 of the container 200 to allow fluid communication between the outlet 229 and the inlet 807. The inlet 807 can be coupled with a pump 806 which provides suction to extract the diluted liquid bleach solution 12 out of the interior containment space 212 and pumps the diluted liquid bleach solution 12 to a tank 808. In at least one example, the diluted liquid bleach solution 12 can be re-injected to the interior containment space 212 to further mix with the water 850 and, in some examples, additional solid bleach until the concentration of the diluted liquid bleach solution 12 is as desired.

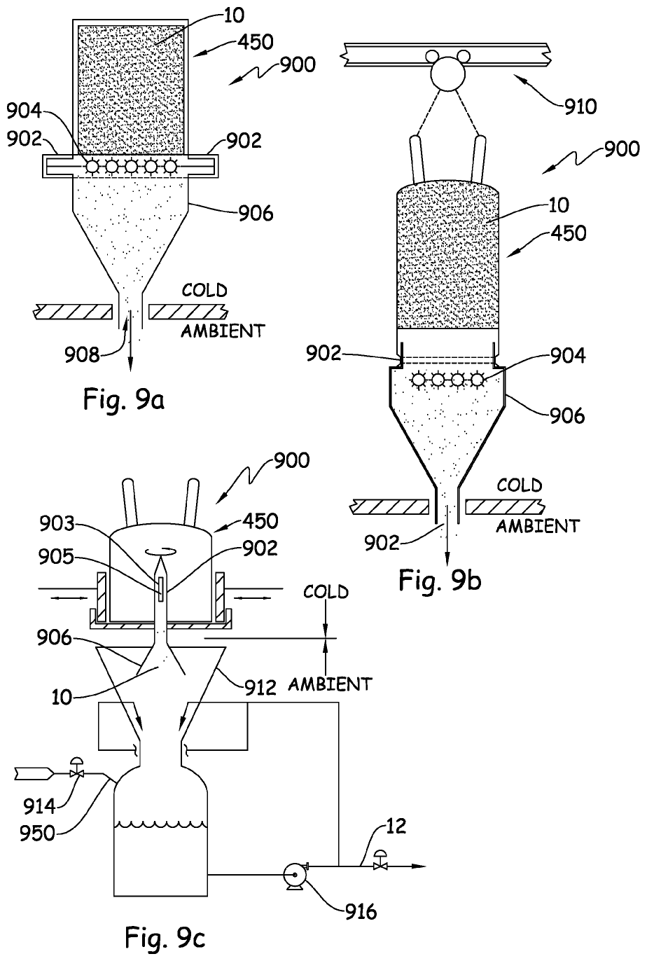

FIGS. 9A-9C illustrate examples of extraction systems 900 for sub-containers, for example the sub-containers 450 in FIGS. 4A-4D. As illustrated in FIG. 9A, the extraction system 900 includes a sump 906 with sloped sides such that the solid bleach slide into the sump 906 and passes through an exit aperture 908 into a receiver. Water can be added to the receiver to dissolve the solid bleach. The sub-container 450 containing the solid bleach 10 can be positioned such that the solid bleach 10 exits the sub-container 450 into the sump 906 positioned below the sub-container 450. In at least one example, as illustrated in FIG. 9A, the sub-container 450 can be fastened to the sump 906 to maintain the positioning of the sub-container 450. In at least one example, the sub-container 450 can be fastened to the sump 906 by clamps 902.

Disposed in or above the sump 906 is a grinder 904. The grinder 904 is configured to pulverize portions of the solid bleach and forms a feed channel through which the pulverized sodium hypochlorite solid bleach is expelled into the sump 906. In at least one example, the grinder 904 can be made of titanium. In other examples, the grinder 904 can be made of any other suitable material which is non-reactive with solid bleach. In at least one example, the grinder 904 controls the release of the solid bleach from the sub-container 450. When the grinder 904 rotates or translates, a desired amount of solid bleach passes through and is removed from the sub-container 450.

As illustrated in FIG. 9B, the sub-container 450 can be coupled with and maneuvered by, for example, a hoist 910. As such, the positioning of the sub-container 450 can be maintained. For example, when the sub-container 450 is a flexible bag, the hoist 910 can prevent the sub-container 450 from collapsing upon itself.

As illustrated in FIG. 9C, the grinder 906 is inserted into the sub-container 450 and extracts the solid bleach as desired. For example, the grinder 906 as illustrated in FIG. 9C can include a sharpened edge 903 which can pulverize or shave off pieces of the solid bleach. The sharpened edge 903 is in communication with a passageway 905 in the grinder 906, through which the pulverized or shaved pieces of the solid bleach pass through. The passageway 905 is in communication with the sump 906, and the pulverized or shaved pieces of the solid bleach are received in the sump 906. An injector 914 can inject water 950 into the sump 906 or the receiving container for the solid bleach such that the water 950 can dissolve the solid bleach to form diluted liquid bleach solution 12. The diluted liquid bleach solution 12 can be extracted by a pump 916. In at least one example, the diluted liquid bleach solution 12 can be re-injected to further mix with the water 950 and, in some examples, additional solid bleach until the concentration of the diluted liquid bleach solution 12 is as desired.

Alternatively, in an aspect, the solid bleach may be stored in a sealable bag. The sealable bag may come in a variety of shapes and volumes. Possible shapes include spherical, square, rectangular, conical or tubular. The sealable bag may have a volume of about 0.1 m³ to about 2 m³. Exemplary volumes include about 0.3 m³ or about 0.4 m³ or about 0.4 m³ or about 0.5 m³ or about 0.6 m³ or about 0.7 m³ or about 0.8 m³ or about 0.9 m³ or about 1.0 m³. The sealable bag is made of a polymeric material, such as plastic. Useful plastics include, but are not limited to polyethylene, polypropylene, butadiene, and fluoropolymers.

In one embodiment, the solid bleach is introduced into the sealable bag and the solid bleach is padded with an inert gas, before the bag is sealed. Examples of inert gases include the noble gases and nitrogen. Methods of sealing the bag include heat sealing and/or the use of a glue. The sealed bag should resist tearing or being punctured and should prevent CO₂ or water from entering.

In an alternate embodiment, after the solid bleach is introduced into the bag, most if not all gases present are removed, and the bag is then sealed. The gases may be removed by compressing the bag, which reduces its volume and forces the gas out. As above, sealing the bag may include heat sealing and/or the use of a glue.

The sealed bags must be shipped under cold temperatures, because melting of the solid bleach is preferably avoided. Suitable temperatures are described herein. The sealed bags may be contained in a frame (such as frame 330), in an open-top, rigid tote or flexible bags or sacks. Alternatively, the sealed bag may be contained in a drum, such as an open-top plastic drum and/or a metal drum with a lid. Since the sealed bag prevents the solid bleach from contacting the drum a liner is not necessary. But if desired, a liner may still be used.

When the sealed bag is ready for use, it may be opened and poured into water to make a bleach solution of a desired strength. Alternatively, water may be added to the opened bag, which dissolves the solid bleach contained therein.

An advantage of the sealed bag is that it allows for the ready shipment of small amounts of solid bleach and it facilitates the use of the solid bleach by the end user. Further, it is possible to add water to the sealed bag and thereby dissolve the solid bleach and form a bleach of desired concentration.

For example, 210 L of water could be combined with 5 Kg of solid bleach pentahydrate, which would result in a 1 wt % solution of bleach (10 g/L). This is the concentration of the disinfectant feed that is commonly used to treat drinking water or waste water. Of course, using more or less water would afford an aqueous bleach solution having a lesser or higher concentration, respectively. These examples apply to pouring the solid bleach pentahydrate into water or adding water to a container (such as a bag) containing the solid bleach pentahydrate.

The disclosures shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the examples described above may be modified within the scope of the appended claims.

1. A storage and transport system for solid sodium hypochlorite pentahydrate, the system comprising:
a container configured to: (a) receive and store crystalline solid sodium hypochlorite pentahydrate (NaOCl.5H₂O) that is comprised of at least 25 percent sodium hypochlorite (NaOCl), to (b) retain decomposition components from crystalline solid sodium hypochlorite pentahydrate stored in the container, and to (c) retain liquid bleach; the container comprising:
a containment wall at least partially surrounding an interior containment space configured to receive solid sodium hypochlorite pentahydrate therein; and
a passage extending from exterior the container to the interior containment space, the passage configured for solid sodium hypochlorite pentahydrate to pass therethrough.

2. The system of claim 1, the container further comprising:
a liner located at an interior surface of the containment wall, the liner being substantially non-reactive with sodium hypochlorite pentahydrate and, without leakage, capable of retaining within the containment space: (a) solid sodium hypochlorite pentahydrate, (b) decomposition components of solid sodium hypochlorite pentahydrate and (c) liquid bleach within the containment space.

3. The system of claim 1, the container further comprising:
an insulation system comprising layer(s) of fiberglass optionally reinforced with plastic insulation encapsulating the container and surrounded by a painted steel jacket, preferably exterior to an integrated refrigeration systems.

4. The system of claim 1, the container further comprising:
an integral dipleg for unloading dissolved solid bleach.

5. The system of claim 1, wherein the containment wall comprises at least one of the following: fiberglass optionally reinforced with plastic, polyethylene, polypropylene, polyvinyl chloride, titanium, stainless steel and carbon steel.

6. The system of claim 2, wherein the liner comprises glass.

7. The system of claim 2, wherein the liner chlorobutyl rubber, polyethylene and/or polypropylene.

8. The system of claim 2, wherein the liner comprises at least one fluoropolymer.

9. The system of claim 1, wherein the container further comprises refrigeration capable of maintaining solid sodium hypochlorite pentahydrate contained within the container at a temperature below approximately five degrees Celsius.

10. The system of claim 1, wherein the container further comprises refrigeration capable of maintaining solid sodium hypochlorite pentahydrate contained within the container at a temperature below approximately 15 degrees Celsius.

11. The system of claim 1, wherein the container further comprises a refrigeration jacket at least partially surrounding the containment wall with a gap space therebetween, the gap space configured to receive refrigerated fluid therein and maintain solid sodium hypochlorite pentahydrate contained within the container at a temperature below approximately 15 degrees Celsius.

12. The system of claim 1, wherein the interior containment space is elongate and comprises a longitudinal axis and substantially uniform cross-sections taken perpendicular to the longitudinal axis.

13. The system of claim 12, wherein the container is an intermodal container configured to be rail transported and the long axis is substantially horizontally oriented in a transport configuration.

14. The system of claim 13, wherein the intermodal container is refrigerated.

15. The system of claim 13, further comprising:
a pair of passages, one proximate each of two ends of the container; and
each passage is located a predetermined distance from a respective end of the container proximate the passage.

16. The system of claim 15, wherein the container is one of: (a) a pressurable rail tank car and (b) a rail-mountable cargo container box.

17. The system of claim 16, further comprising:
a container tilting system capable of lengthwise tilting an elongate container located thereupon at an angle to horizontal, wherein the angle of tilt establishes a tilt angle of a longitudinal axis of the container and the angle of tilt is approximately equal to the angle of repose of solid sodium hypochlorite pentahydrate.

18. The system of claim 16, further comprising:
a railcar tilting system capable of lengthwise tilting a railcar mounted elongate container located thereupon at an angle to horizontal, wherein the angle of tilt establishes a tilt angle of a longitudinal axis of the container and the angle of tilt is approximately equal to the angle of repose of solid sodium hypochlorite pentahydrate.

19. The system of claim 18, wherein the tilt angle is between approximately 30 and 80 degrees.

20. The system of claim 18, wherein the tilt angle is between approximately 40 and 70 degrees.

21. The system of claim 15, wherein the predetermined distance that each passage is located from the respective end of the container proximate the passage is substantially equal.

22. The system of claim 15, wherein the predetermined distance that each passage is located from the respective end of the container proximate the passage is determined in dependence upon spreading characteristics of an associated solid sodium hypochlorite pentahydrate filler system.

23. The system of claim 22, wherein the predetermined distance that each passage is located from the respective end of the container proximate the passage is determined in dependence upon in-container spreading characteristics of an associated solid sodium hypochlorite pentahydrate filler system.

24. The system of claim 1, further comprising:
a filler system configured to convey solid sodium hypochlorite pentahydrate from a supply source to and through a passage and into the containment space; and
the filler system comprising a spreader that in a filling configuration is located proximate a passage and is configured to spread solid sodium hypochlorite pentahydrate within the containment space as far as a lengthwise center-point of the containment space.

25. The system of claim 24, wherein the spreader further comprises a distributor configured to distribute, substantially uniformly, solid sodium hypochlorite pentahydrate from below the spreader to at least as far as a width-wise centerline located at the lengthwise center-point of the containment space.

26. The system of claim 25, wherein the distributor comprises a rotary head that broadcasts, substantially uniformly, solid sodium hypochlorite pentahydrate from below the spreader to at least as far as a width-wise centerline located at the lengthwise center-point of the containment space.

27. The system of claim 24, wherein the filler system comprises a solid sodium hypochlorite pentahydrate conveyance pathway enclosed from the ambient atmosphere and into which CO₂ scrubbed air is injected.

28. The system of claim 27, wherein the filler system pneumatically conveys solid sodium hypochlorite pentahydrate along at least a portion of the conveyance pathway between the supply source and the containment space.

29. The system of claim 24, wherein the filler system comprises a solid sodium hypochlorite pentahydrate conveyance pathway enclosed from the ambient atmosphere and into which nitrogen is injected.

30. The system of claim 1, wherein the container comprises a pressure relief configured to control venting of gas produced within the container when the container is in a closed configuration.

31. The system of claim 30, wherein the pressure relief comprises a one-way valve configured to release pressure above a predetermined limit.

32. The system of claim 30, wherein the pressure relief comprises micro-porous hydrophobic material.

33. The system of claim 32, wherein the micro-porous hydrophobic material is polytetrafluoroethylene.

34. The system of claim 1, further comprising a solid sodium hypochlorite pentahydrate extraction system comprising:
a water delivery system configured to deliver water into the containment space and dissolve a portion of solid sodium hypochlorite pentahydrate stored therein; and
the extraction system having an inlet positioned at a collection point for diluted liquid bleach produced by delivered water mixing with stored solid sodium hypochlorite pentahydrate in the containment space.

35. The system of claim 34, wherein the water delivery system comprises an injector extendable into the containment space through a passage.

36. The system of claim 34, wherein the collection point for diluted liquid bleach is located at a lower portion of the container and into which diluted liquid bleach gravity flows.

37. The system of claim 34, further comprising a screen located proximate the inlet of the extraction system that is positioned to inhibit the passage of solids into the inlet.

38. The system of claim 1, further comprising a solid sodium hypochlorite pentahydrate extraction system comprising:
a fluid delivery system configured to deliver dilute bleach into the containment space and dissolve a portion of solid sodium hypochlorite pentahydrate stored therein; and
the extraction system having an inlet positioned at a collection point for strengthened liquid bleach produced by delivered dilute bleach mixing with stored solid sodium hypochlorite pentahydrate in the containment space
